(19) United States
(12) Patent Application Publication
(10) Pub. No.: US 2026/0089138 A1
(43) Pub. Date: Mar. 26, 2026

(54) DYNAMIC BRINGUP OF SECURE TUNNELING OF ACCESS-CONTROLLED NETWORK DOMAIN INTERCONNECT TRAFFIC

(71) Applicant: Cisco Technology, Inc., San Jose, CA (US)

(72) Inventors: Anbu Chezhian Gunalan, San Jose, CA (US); Chennakesava Reddy Gaddam, Bangalore (IN); Jiri Chaloupka, San Jose, CA (US); Swadesh Agrawal, Fremont, CA (US); Michael William MacKenzie, Kanata (CA)

(21) Appl. No.: 18/896,762

(22) Filed: Sep. 25, 2024

(51) Int. Cl. H04L 9/40; H04L 45/02; H04L 45/748

(52) U.S. Cl. CPC H04L 63/029; H04L 45/04; H04L 45/748; H04L 63/0435

(57) ABSTRACT

Methods and devices provide improved secure tunneling of interconnect traffic across access-controlled network domains, by configuring network devices according to a dynamic tunnel bringup method to discover peer network devices, establish a tunnel gateway in a security association, monitor a security association session status, and update routing and forwarding tables in accordance. A processing unit of a network device configures the network device to discover a peer network device; update a next hop in a local routing table; establish a tunnel endpoint; encapsulate an encrypted packet with a SA tag; monitor a SA session status; and advertise routing information based on a monitored SA session status.

### TECHNICAL FIELD

The present disclosure relates generally to dynamically bringing up secure tunnels for interconnect traffic across access-controlled network domains.

### BACKGROUND

Conventionally, in order to implement an access-controlled network domain including a VPN between two networks implemented by an IP tunnel, access-controlled network domains can be implemented by the Internet Protocol Security (“IPsec”) protocol. Access-controlled network domains not based on IPsec, such as CISCO TRUSTSEC and other implementations based on MACsec, can implement IP tunnels using circular forwarding reserved ports as endpoints of the IP tunnel, thereby enabling broader implementation of access-controlled network domains by protocols other than IPsec.

Each packet which ingresses into the access-controlled network domain may only be routed over secure network links in order to ultimately egress from the network domain. However, encryption of packets by the above-mentioned protocols such as IPsec and MACsec may, due to the computational overhead of cryptographic computations, delay packet ingress and thus reduce throughput of a network link to less than its full throughput. It is desired to implement IPsec over a secure network link while achieving “line-rate IPsec,” such that packets are encrypted while ingressing at the full throughput of the network link.

A network-hosting organization which has purchased some number of physical network devices implemented as a network infrastructure including one or more networks, and which has configured an access-controlled network domain over these one or more networks based on the physical network infrastructure, may later wish to change the configuration of the access-controlled network domain. For example, the organization may wish to scale up the access-controlled network domain to serve more customers. Furthermore, traffic from existing customers may increase. Such traffic increases can impact line-rate IPsec if secure network links are not reconfigured in accordance.

As the number of network devices of an access-controlled network domain grows, it may be desired to scale up configuration of the network domain by adding more endpoints to secure network links. Users may also add to the number of endpoints and network devices connecting to the access-controlled network domain, and they may desire to configure added endpoints and network devices to connect over existing secure network links rather than establish new secure network links.

Consequently, there is a need to enable bringup of IP tunnels in a more flexible fashion.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The devices depicted in the accompanying figures are not to scale and components within the figures may be depicted not to scale with each other.

FIG. 1 illustrates an access-controlled network domain implemented over a physical layer of one or more networks, according to example embodiments of the present disclosure.

FIG. 2 illustrates a device-architecture diagram of an example network device implementing establishment of secure network links.

FIG. 3 illustrates a flowchart of a dynamic tunnel management method according to example embodiments of the present disclosure.

FIGS. 4A and 4B illustrate alternative implementations of Border Gateway Protocol (“BGP”) to apply one or more network policies to IP tunnel gateways according to example embodiments of the present disclosure.

FIG. 5 illustrates a flowchart of a surrogate encryption method according to example embodiments of the present disclosure.

FIG. 6 shows an example architecture for a network device capable of being configured to implement the functionality described above.

### DESCRIPTION OF EXAMPLE EMBODIMENTS

### Overview

This disclosure describes techniques for improving secure tunneling of interconnect traffic across access-controlled network domains, by configuring network devices according to a dynamic tunnel bringup method to discover peer network devices, establish a tunnel gateway in a security association, monitor a security association session status, and update routing and forwarding tables in accordance.

The described techniques may be implemented in one or more network devices having one or more network processing units configured to execute computer-executable instructions. The processing units may be configured by one or more non-transitory computer-readable media storing computer-executable instructions that, when executed by the processing units cause the processing units to perform the steps.

The methods includes a processing unit of a network device configuring the network device to discover a peer network device; update a next hop in a local routing table; establish a tunnel gateway; encapsulate an encrypted packet with a SA tag; monitor a SA session status; and advertise routing information based on a monitored SA session status.

Additionally, the techniques described herein may be performed by a device having non-transitory computer-readable media storing computer-executable instructions that, when executed by one or more processors, performs the method described above.

### Example Embodiments

According to example embodiments of the present disclosure, a network is configured by a network administrator over an infrastructure including network hosts and network devices in communication according to one or more network protocols. Outside the network, any number of client devices, external devices, and the like can connect to hosts of the network in accordance with a network protocol and access controls. An access-controlled network domain refers to some number of commonly administrated networks configured over an infrastructure including network hosts and network devices in communication according to one or more network protocols. Connection to any network of the access-controlled network domain by any networked device (“endpoint”) outside of the network domain is subject to access controls which may allow or may block the connection. One or more networks according to example embodiments of the present disclosure may include wired and wireless local area networks (“LANs”) and such networks supported by IEEE 802 LAN standards. Network protocols according to example embodiments of the present disclosure may include any protocol suitable for delivering data packets through one or more networks, such as IP data routing.

It should be understood that there is no categorical distinction between networked devices connecting to the network domain (such as endpoints, by way of example) and networked hosts within the network domain; the term “endpoint” as used herein merely logically distinguishes devices connecting to the network domain from hosts within the network domain.

It should be understood that endpoints can include computing devices and systems operated by end users, organizational personnel, and other users, which connect to a campus network as described subsequently. Endpoints can also include external devices such as rack servers, load balancers, and the like, which connect to a data center as described subsequently.

The network can be configured to host various computing infrastructures; computing resources; software applications; databases; computing platforms for deploying software applications, databases, and the like; application programming interface (“API”) backends; virtual machines; and any other such computing service accessible by users accessing the network from one or more endpoints. Networks configured to host one or more of the above computing services can be characterized as private cloud services, such as data centers; public cloud services; and the like. Such networks can include physical hosts and/or virtual hosts, and such hosts can be located in a fashion collocated at premises of one or multiple organizations, distributed over disparate geographical locations, or a combination thereof.

A network administrator can control access to the network by configuring a network domain encompassing computing hosts of the network and network devices of the network. A network administrator can further configure a computing host as a domain controller, the domain controller being configured to handle authentication requests from endpoints by an authentication protocol, so that endpoints that successfully authenticate can establish a network connection to the network domain.

Computing hosts of the network can be servers which provide computing resources for hosted frontends, backends, middleware, databases, applications, interfaces, web services, and the like. These computing resources can include, for example, computer-executable applications, databases, platforms, services, virtual machines, and the like.

Network devices are configured to deliver data packets through one or more networks, such as personal area networks (“PANs”), wired and wireless local area networks (“LANs”), wired and wireless wide area networks (“WANs”), the Internet, and so forth. A network device, such as a router, switch, or firewall, can receive, over one or more network interfaces, packets forwarded over one or more networks from other hosts; determine a next hop, route, and/or destination to forward the packets to; and forward the packets, over one or more network interfaces, to a host determined by the next hop, route, and/or destination. The next hop, route, and/or destination in the one or more networks can be determined by any, or any combination of, static routing tables and various dynamic routing algorithms. Such path computation can be performed according to IP routing

According to example embodiments of the present disclosure, network devices of the access-controlled network domain include routers and switches. A network device can be a physical electronic device having one or more network processing units (“NPUs”) and/or one or more application specific integrated circuits (“ASICs”), each configured to execute computer-executable instructions. NPUs can be configured by one or more non-transitory computer-readable media storing computer-executable instructions that, when executed by processing units, cause the processing units to perform the steps. The computer-executable instructions can also be stored on memory of one or more ASICs. According to example embodiments of the present disclosure, memory can include, for example, ternary content addressable memory (“TCAM”), which an ASIC may be configured to write data to and read data from.

In one or more networks of an access-controlled network domain, a physical layer of the network may be defined by some number of such network devices.

A network device such as a router or switch receives packets forwarded over one or more network links from a host internal to or external to the one or more networks; determines a next hop, route, and/or destination to forward the packets to; and forwards the packets to a host internal to or external to the one or more networks, determined by the next hop, route, and/or destination. A network device may be configured to determine a next hop, route, and/or destination by any combination of static routing tables and various dynamic routing algorithms.

According to example embodiments of the present disclosure, “access controls” refer to any implementation of LAN standards which allow access to some endpoints outside the access-controlled network domain, and block access to other endpoints outside the access-controlled network domain to a physical transmission medium of one or more networks of the access-controlled network domain. Allowance and blocking of access may reflect various security policies which describe endpoints which are authorized to access the access-controlled network domain and endpoints which are not authorized to access the access-controlled network domain. For example, a security policy may be based on an identity of an endpoint device being that of a device authorized to access the access-controlled network domain; an identity of a user of an endpoint device being that of a user authorized to access the access-controlled network domain; a software configuration of an endpoint device complying with security standards conditional to access the access-controlled network domain; security of an endpoint device not being compromised by a malicious attack; and such rules as a network administrator may define for the purpose of securing the access-controlled network domain against unauthorized access.

Among network devices of one or more networks of the access-controlled network domain, some network devices may be configured as network access devices. Network access devices may perform ingress enforcement by determining characteristics of an endpoint; comparing characteristics of an endpoint to a security policy; and then classifying the endpoint having the characteristics as belonging to one of multiple groups, including at least one group made up of endpoints authorized to access the access-controlled network domain, and at least one group made up of endpoints not authorized to access the access-controlled network domain. Such a security policy may include any of, but need not be limited to, the above examples of security standards.

Network access devices are configured to perform ingress enforcement by various authentication protocols. An authentication protocol can include the IEEE 802.1X LAN standard, which configures the network access device as an authenticator which receives credentials sent over a network link from a supplicant running on an endpoint, sends received credentials to an authentication server (outside the access-controlled network domain) for validation, and, based on validation outcomes returned from the authentication server, allows or blocks traffic between the endpoint and one or more networks of the access-controlled network domain. Furthermore, an authentication protocol according to the 802.1X standard can be extended in accordance with the 802.1X-REV standard, which configures the network access device to further perform key exchange based on the MACsec Key Agreement (“MKA”) protocol.

An authentication protocol can include the MAC Authentication Bypass protocol, which configures the network access device as an authenticator which determines a MAC address of the endpoint, sends the MAC address to an authentication server for validation, and, based on validation outcomes returned from the authentication server, allows or blocks traffic between the endpoint and one or more networks of the access-controlled network domain.

An authentication protocol can include any other suitable protocol implemented in accordance with World Wide Web standards for authenticating an endpoint device, or a user of the endpoint device, as being authorized to access a network, such as Web Authentication as published by the World Wide Web Consortium. Such other authentication protocols likewise configure the network access device as an authenticator which determines authentication credentials of the endpoint according to the protocol, sends the authentication credentials to an authentication server for validation, and, based on validation outcomes returned from the authentication server, allows or blocks traffic between the endpoint and one or more networks of the access-controlled network domain.

The validation outcome returned from the authentication server can further include one or more authorization policies. Authorization policies can configure network access devices to identify various endpoints, and classify data packets received from endpoints in accordance with respective endpoint identities. For example, authorization policies can configure network access devices to identify endpoints as assigned to different security groups, and to tag packets received from endpoints of different security groups with different security group tags (“SGTs”). For example, authorization policies can configure network access devices to enforce access control lists (“ACLs”), by identifying endpoints as authorized to access the access-controlled network domain or not authorized to access the access-controlled network domain, according to whether endpoint IP addresses are present on an ACL or not.

Furthermore, authorization policies can configure network access devices to tag packets with SGTs, and to enforce ACLs by identifying endpoints as authorized to access the access-controlled network domain or not authorized to access the access-controlled network domain according to whether data packets are tagged with SGTs present on an ACL or not. According to example embodiments of the present disclosure, such authorization policies are referenced as security group based access control lists (“SGACLs”). Such role-based ACLs may map a group of IP addresses to a common role (e.g., a common security group number), minimizing the size of data stored in ACLs.

Thus, after any authenticator as described above has validated authorization of an endpoint to access one or more networks of the access-controlled network domain and has allowed traffic between the endpoint and the one or more networks, data packets originating from the endpoint may be tagged with an SGT at a network access device 104. Subsequently, network devices of the access-controlled network domain may forward tagged packets across any number of network links across one or more networks of the access-controlled network domain.

Access-controlled network domains according to example embodiments of the present disclosure further implement secure transmission of data over network links. Network devices of an access-controlled network domain may be configured to securely transmit data by, for example, encrypting packets according to an encryption standard enforced by a network security protocol. A network security protocol may include the IEEE 802.1AE LAN standard, which configures any number of ports of a network device to encrypt and decrypt packets according to the Media Access Control Security (“MACsec”).

In some network devices, transceiver integrated circuits underlying the sending and receiving functionality of ports according to LAN standards may be each referred to as a physical layer circuit, commonly referred to as an “Ethernet PHY” or “PHY.” The physical circuit design of each PHY may determine characteristics of a respective port of a network device, such as a bitrate of each respective port and the LAN standards which each respective port may support in sending and receiving packets. Subsequently, for ease of reference, a “port” according to example embodiments of the present disclosure shall refer to one or more integrated circuits of a PHY which define transceiver functionalities of a respective port of a network device.

According to example embodiments of the present disclosure, some network devices include PHYs, which have encryption and decryption circuits which may be configured to perform encryption and decryption of data according to one or more encryption standards (such as Advanced Encryption Standard (“AES”)). Moreover, some network devices do not include PHYs, and, for such network devices, NPUs can be configured to perform encryption and decryption of data according to one or more encryption standards. For the present disclosure, a PHY configured to encrypt and decrypt data, and an NPU configured to encrypt and decrypt data, may each be referenced as a “cryptographic engine.”

Two network devices connected by a network link may, in accordance with a key exchange protocol, such as Internet Key Exchange (“IKE”), Security Association Protocol (“SAP”), MKA protocol as described above, and the like, exchange secret keys to establish a pair of security associations (“SAs”), where, at each of the two network devices, one SA is inbound and the other SA is outbound. Each of the two SAs provides for encrypting outbound data packets using a secret key; secret keys can be the same or different between the two SAs.

By negotiation of a SA, SAKs exchanged between the two network devices secure outbound traffic from either network device to the other and inbound traffic from either network device to the other, allowing a cryptographic engine of either network device to encrypt packets which the other cryptographic engine may decrypt, and to decrypt data packets encrypted by the other cryptographic engine. For the purpose of an access-controlled network domain, each network link between network devices of the network domain must be a secure network link.

The above-mentioned techniques for implementing an access-controlled network domain may be implemented individually, or may be implemented collectively in any suitable combination thereof, where any of the above-mentioned techniques may be replaced with a suitable technique known to persons skilled in the art for implementing a similar outcome, without limitation to the above-described techniques. For example, CISCO SYSTEMS, INC. of San Jose, California provides various network architectures under the CISCO TRUSTSEC name, which describes various collective implementation of the above-described techniques over one or more networks to implement an access-controlled network domain.

It should be understood that a cryptographic engine processing packets in a circular forwarding mode further enables the access-controlled network domain to include a virtual private network (“VPN”) between two networks, implemented by an IP tunnel between the two networks. As known to persons skilled in the art, an IP tunnel between two networks can be implemented between physical interfaces of a network device of each network, or between virtual interfaces (such as loopback interfaces) of a network device of each network.

It should be understood, however, that example embodiments of the present disclosure may be implemented according to any of the several versions of the CISCO TRUSTSEC specifications as known to persons skilled in the art, or may be implemented according to other specifications for access-controlled network domains as described above. For example, while the implementation of SGTs, ACLs, or SGACLs may facilitate authorization of endpoint devices joining an access-controlled network domains (and the use of TCAM lookup by a processing unit according to implementations of SGACLs, for example, does not conflict with the modifications to TCAM lookup as shall be subsequently described), persons skilled in the art will appreciate that access-controlled network domains may be implemented without these techniques. Access-controlled network domains may be implemented by implementing only an authentication protocol and a network security protocol over one or more networks underlying the access-controlled network domain, such as according to standalone implementations of MACsec.

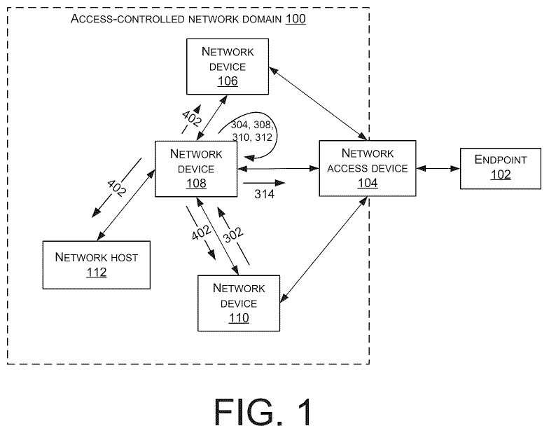

FIG. 1 illustrates an access-controlled network domain 100 implemented over a physical layer of one or more networks, according to example embodiments of the present disclosure. An endpoint 102, addressed outside of the one or more networks and outside the access-controlled network domain 100, accesses the access-controlled network domain 100 by an ingress network link to a network access device 104, such as a network link to a switch configured as an authenticator. Further example network devices of one or more networks of the access-controlled network domain 100 are labeled herein as 106, 108, and 110, but it should be understood that the one or more networks may include any number of other network devices not illustrated herein. One or more networks of the access-controlled network domain 100 may further include any number of network hosts; an example network host of one or more networks of the access-controlled network domain 100 is labeled herein as 112, but it should be understood that the one or more networks may include any number of other network hosts not illustrated herein.

It should be understood that there is no categorical distinction between networked devices connecting to the network domain (such as endpoints, by way of example) and networked hosts within the network domain; the term “endpoint” as used herein merely logically distinguishes devices connecting to the network domain from hosts within the network domain.

It should further be understood that any number of network links may be established between network devices of the one or more networks and/or network hosts of the one or more networks, including secure network links and non-secure network links. The network links illustrated in FIG. 1 should be understood as being secure network links. Further secure and/or non-secure network links between the illustrated network devices and network hosts may be established, but they are not illustrated herein. Further network links may be established from the illustrated network devices and network hosts to other network devices and network hosts not part of the one or more networks of the access-controlled network domain 100; these further network links, whether secure or non-secure, are not illustrated herein.

Further hosts described above which are not part of the access-controlled network domain 100, such as an authentication server, are also not illustrated herein.

Conventionally, configuring an added endpoint requires a user to configure the added endpoint at each network device where an IP tunnel is brought up according to IPsec, and configure an SA at each added endpoint, even if it will not carry traffic for any hosted service. Source and destination IP addresses must be configured for each pair of endpoints of an IP tunnel, so as to secure traffic in both directions, and the IP tunnel must be advertised to network devices so that routing over the link can be resolved. Alternatively, an ACL can be edited to redirect traffic to the IP tunnel. In each case, such manual configuration can be cumbersome and labor-intensive.

Thus, example embodiments of the present disclosure provide methods and devices to dynamically bring up a secure network link between any two network devices including at least one network device in an access-controlled network domain. Methods and devices according to example embodiments of the present disclosure enable network devices in an existing access-controlled network to learn next hops by border gateway protocol peer discovery.

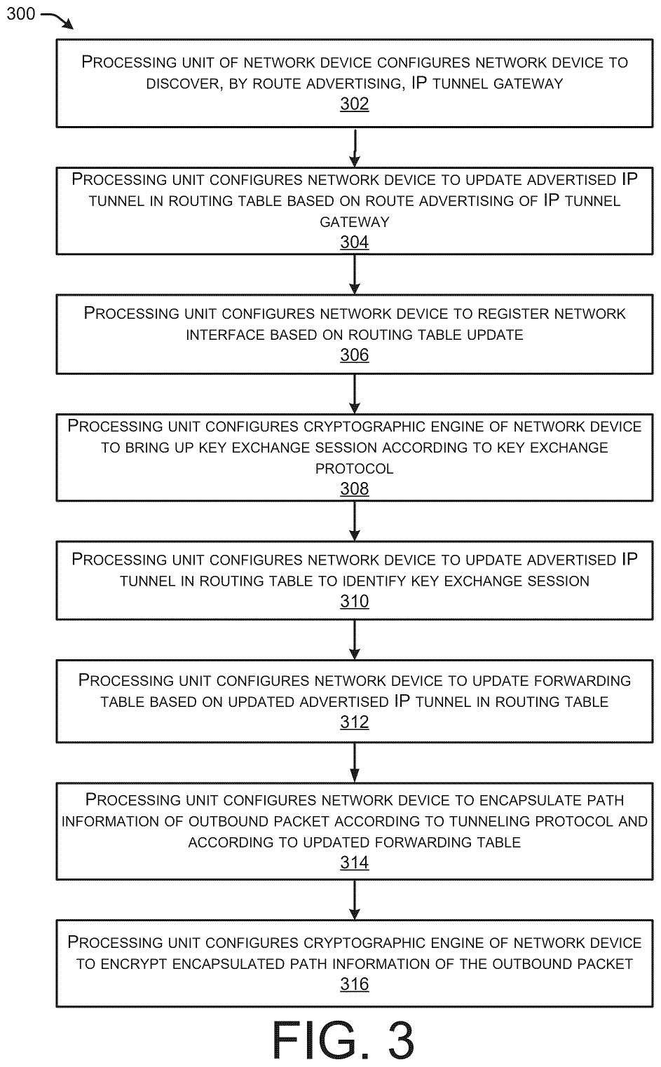

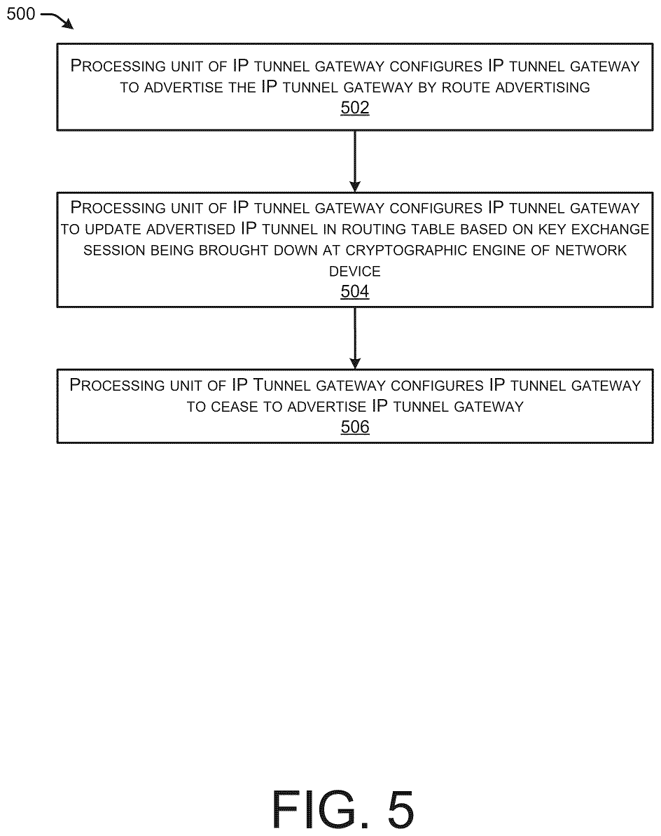

According to a dynamic tunnel bringup method of example embodiments of the present disclosures, after a network device such as those illustrated in FIG. 1 is configured to establish any secure network link according to IPsec, MACsec, or any other IP tunnel protocol as described above, the network device is further configured to, as described in further detail subsequently with respect to FIGS. 3 and 5, discover a peer network device (step 302 of FIG. 3); configured to update a next hop in a local routing table (step 304 of FIG. 3); configured to establish a tunnel gateway (steps 308, 310, and 312 of FIG. 3); configured to encapsulate an encrypted packet with a SA tag (step 314 of FIG. 3); configured to monitor a SA session status; and configured to advertise routing information based on a monitored SA session status (step 402 of FIG. 5).

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

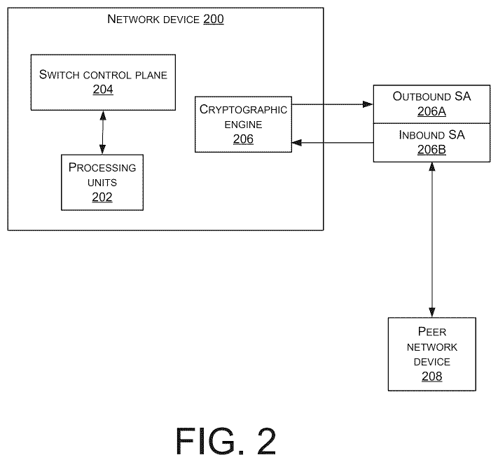

FIG. 2 illustrates a device-architecture diagram of an example network device 200 implementing establishment of secure network links.

As described above, the network device 200 can be an electronic device having one or more of multiple types of hardware components (or nodes) installed, including network processing units 202. The network processing units 202 are configured to perform each of the steps as subsequently described with reference to the method of FIG. 3. The network processing units 202 may be configured to perform each of the below-described steps by one or more non-transitory computer-readable media storing computer-executable instructions that, when executed by the network processing units 202, cause the network processing units 202 to perform the steps.

The computer-executable instructions which configure the network processing units 202, as well as any data written, read, and modified in the course of executing these instructions, can be collectively referred to as a switch control plane 204.

The network device 200 further includes at least one cryptographic engine 206, the cryptographic engine 206 being operative to transmit and receive encrypted data packets as electrical signals on at least two SAs. As mentioned above, the cryptographic engine 206 can be network processing units 202, or can be a PHY of the network device 200. Herein, an outbound SA is labeled 206A, and an inbound SA is labeled 206B.

It should be understood that the network device 200 can be in communication with a peer network device (not illustrated herein); in the event that the network device 200 has established a network link with another network device (not illustrated herein) and the respective network devices have established a secure connection and negotiated a SA over the network link, thereby establishing a secure network link therebetween, the network device 200, with regard to its secure network link with the peer network device, is considered part of an access-controlled network domain 100 according to example embodiments of the present disclosure.

Additionally, FIG. 2 illustrates a peer network device 208 in communication with the network device 200. The peer network device 208 can have a respective cryptographic engine (not illustrated herein).

Example embodiments of the present disclosure provide a network device 200 which is configured according to a dynamic tunnel bringup method.

FIG. 3 illustrates a flowchart of a dynamic tunnel bringup method 300 according to example embodiments of the present disclosure. As described above, each of the steps of the dynamic tunnel bringup method 300 can be performed by NPUs of a network device, configured by one or more non-transitory computer-readable media storing computer-executable instructions to perform steps according to a dynamic tunnel bringup method.

In a step 302 of the dynamic tunnel bringup method 300, a processing unit of a network device configures the network device 200 to discover, by route advertising, an IP tunnel gateway.

Two peer network devices (i.e., the network device and the peer network device as described above) can establish a common SA by bringing up a key exchange session according to a key exchange protocol, causing the configuration of matching SA keys at the two peer network devices. For brevity, the network device and the peer network device may be subsequently referred to as the “SA members.”

Before the SA is established, the network device first discovers, by route advertising, an IP tunnel gateway. According to the dynamic tunnel bringup method, the peer network device configured as an IP tunnel gateway is advertised by route advertising according to an implementation of Border Gateway Protocol (“BGP”)—that is, one of various gateway protocols which cause IP tunnel configuration to be distributed to endpoints.

According to IPsec, MACsec, or any other IP tunnel protocol as described above, IP tunnel configuration establishes two SA members as two tunnel endpoints of an IP tunnel. To avoid confusion of tunnel endpoints with “endpoint” in the general sense as described above, such two endpoints of an IP tunnel are subsequently described as “tunnel gateways” of an IP tunnel.

Moreover, according to IPsec, MACsec, or any other IP tunnel protocol as described above, IP tunnel configuration includes applying one or more network policies to the tunnel gateways. Network policies include routing policies which configure IP forwarding of packets by a network device, and include route advertising policies which configure advertising of routes by a network device to peer network devices. Routing policies can define destinations for packets forwarded over an IP tunnel, based on characteristics of the packets.

By way of example, a network policy can be applied according to BGP over network devices reachable over a range of IP addresses identified by a common IP prefix, where each prefix can define, in a routing table, a different destination for packets forwarded over an IP tunnel. By way of another example, a network policy can be applied according to BGP over network devices reachable over a common VRF (virtual routing and forwarding) virtually defined by a routing table, where each VRF can define, in a routing table, a different destination for packets forwarded over an IP tunnel.

By way of yet another example, a network policy can be applied according to BGP over network devices reachable over a common BGP community defined by a BGP color tag. According to BGP implementations, BGP color tags can be assigned to distinct IP prefixes, and each BGP color tag can define, in a routing table, a different destination for packets forwarded over an IP tunnel.

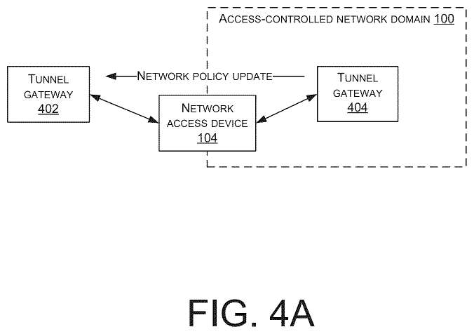

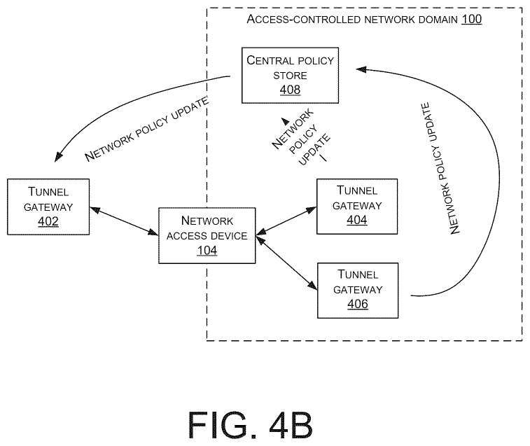

Network policies configure tunnel gateways by multiple alternative implementations of BGP. FIGS. 4A and 4B illustrate alternative implementations of BGP to apply one or more network policies to IP tunnel gateways 402, 404, and 406 according to example embodiments of the present disclosure. FIG. 4A illustrates an implementation of BGP by distributed network policies: network policies are stored locally at each tunnel gateway 402 and 404, and each tunnel gateway 402 and 404, upon locally updating a network policy according to BGP, forwards the network policy update to the peer tunnel gateway, respectively 404 and 402.

FIG. 4B illustrates an implementation of BGP by centralized network policies: each tunnel gateway 402, 404, and 406, upon locally updating a network policy according to BGP, forwards the network policy update to a central policy store 408 of an access-controlled network domain 100, such as a BGP route reflector or a BGP speaking controller. The central policy store forwards the network policy update to other tunnel gateways.

According to examples of the present disclosure, a network policy update is recorded in a data format, such as a Type-Length-Value (“TLV”) format, to state an IP tunnel protocol configured, such as IPsec and MACsec, as described above. TLV refers to any encoding format which encodes a value for a particular type of field, where the type of the field is encoded in a type field, the length of the value is encoded in a length field, and the value is encoded in a value field.

For example, TLVs can include an IP tunnel type, and a sub-TLV including an IP tunnel protocol. The respective formats of such a header TLV and sub-TLV are shown below:

| | |
|---|---|
| +−+−+−+−+−+−+−+−+−+−+−+−+−+−+−+−+−+−+−+−+−+−+−+−+−+−+−+−+−+−+− | + |
| \| Tunnel Type (2 Octets) \| Length (2 Octets) | \| |
| +−+−+−+−+−+−+−+−+−+−+−+−+−+−+−+−+−+−+−+−+−+−+−+−+−+−+−+−+−+−+− | + |
| \| | \| |
| \| value (list of sub-tlvs) | \| |
| \| | \| |
| +−+−+−+−+−+−+−+−+−+−+−+−+−+−+−+−+−+−+−+−+−+−+−+−+−+−+−+−+−+−+− | + |
| +−+−+−+−+−+−+−+−+−+−+−+−+−+−+−+−+−+−+−+−+−+−+−+−+−+−+−+−+−+−+−+− | + |
| \| sub-tlv type (1 Octets) \| Length (2 Octets) | \| |
| +−+−+−+−+−+−+−+−+−+−+−+−+−+−+−+−+−+−+−+−+−+−+−+−+−+−+−+−+−+−+−+− | + |
| \| | \| |
| \| IPsec/MACsec | \| |
| \| | \| |
| \| | \| |
| +−+−+−+−+−+−+−+−+−+−+−+−+−+−+−+−+−+−+−+−+−+−+−+−+−+−+−+−+−+−+−+− | + |

Network policies recorded as a TLV as described herein can be further stored in headers of packets according to any packet encapsulation format which enables entry of information regarding nodes along a path of the packet, and which enables such entries to be updated on a per-hop basis by each node that the packet is forwarded over, such as IP header encapsulation formats.

According to examples of the present disclosure, a network device configured according to a dynamic tunnel bringup method can insert information entries into headers of received packets prior to forwarding those packets outbound. These information entries may include information, in a defined format such as a TLV format as described above, indicating an IP tunnel type and an IP tunnel protocol.

In a step 304 of the dynamic tunnel bringup method 300, a processing unit configures the network device to update an advertised IP tunnel in a routing table based on the route advertising of the IP tunnel gateway.

In accordance with the above alternative implementations of BGP, route advertisement of an IP tunnel gateway can be performed by an NPU of the peer network device, peering with other network devices by Interior Gateway Protocol (“IGP”). Alternatively, route advertisement of an IP tunnel gateway can be configured by a BGP policy stored at a central policy store of an access-controlled network domain, such as a BGP route reflector or a BGP speaking controller. An NPU of the network device 200 can receive route advertising over a port, and can build and update a local routing table based on the received route advertising. Route advertising can include receiving network policy updates stored in a format such as the TLV format presented above, and encapsulated in headers of IP packets.

Based on route advertising transmitted in a received packet, the network device learns that the peer network device configured as an IP tunnel gateway can be reached as a next hop over an advertised IP tunnel. The network device is configured to update a routing information base (“RIB”) table to add an address of the peer network device as a next hop.

The learned address of the peer network device configured as an IP tunnel gateway is subsequently used to encapsulate an outbound packet as subsequently described with reference to step 314.

In a step 306 of the dynamic tunnel bringup method 300, a processing unit configures the network device to register a network interface based on the routing table update. The registered network interface can be a virtual network interface (“NVE”).

In a step 308 of the dynamic tunnel bringup method 300, a processing unit configures a cryptographic engine of the network device to bring up a key exchange session according to a key exchange protocol.

Bringing up a key exchange session configures a cryptographic engine of the network device to bring up a cryptographic session according to IP tunnel protocols such as IPsec and MACsec, as described above. The cryptographic engine receives an exchange of secret keys with a peer network device configured as an IP tunnel gateway according to a key exchange protocol, such as SAP, MKA, and the like for the negotiation of SAs. As part of negotiating the SAs, the network devices exchange protocol data units (“PDUs”) defined according to the key exchange protocol. It should be understood that each network device may receive the other network device's PDU, and processing units at the network device may be configured to record the PDU of the peer network device at a switch control plane. The configured cryptographic engine thereafter has an SA tag for the duration of the cryptographic session, identifying the negotiated SAs.

The SA negotiation and key exchange establish the two SA members as two tunnel gateways of an IP tunnel.

In a step 310 of the dynamic tunnel bringup method 300, a processing unit configures the network device to update the advertised IP tunnel in the routing table to identify the key exchange session.

By adding the SA tag to the advertised IP tunnel identified in the routing table, the SA session identified by the SA tag is identified in association with the next hop in the advertised IP tunnel.

In a step 312 of the dynamic tunnel bringup method 300, a processing unit configures the network device to update a forwarding table based on the updated advertised IP tunnel in the routing table.

By adding the IP tunnel and the SA tag to a forwarding information base (“FIB”) table, the network device is configured to forward inbound packets over the advertised IP tunnel in accordance with the key exchange session.

In a step 314 of the dynamic tunnel bringup method 300, a processing unit configures the network device to encapsulate path information of an outbound packet according to a tunneling protocol and according to the updated forwarding table.

A tunneling protocol configures the network device to encapsulate an outbound packet to deliver the packet over a secure network link such as an IP tunnel. By way of example, a tunneling protocol is Generic Routing Encapsulation (“GRE”).

The network device can encapsulate the outbound packet, wherein next hop information is written into the outbound packet as a destination address of the outbound packet. As mentioned above with reference to step 304, the next hop information can include the learned address of the peer network device configured as an IP tunnel gateway.

In a step 316 of the dynamic tunnel bringup method 300, a processing unit configures a cryptographic engine of the network device to encrypt encapsulated path information of the outbound packet.

To forward the outbound packet securely over an advertised IP tunnel, the cryptographic engine is configured to identify an SA session according to the SA tag, and thereby determine that encapsulated path information written according to IP routing, as well as payload of the outbound packet, should be encrypted. In accordance with principles of network security, a header of an encrypted packet will not identify a destination address of the packet, a next hop of the packet, a routing path of the packet, or any other information which enables the processing unit to forward the packet.

Subsequently, a processing unit can configure the network device to forward the outbound packet over the advertised IP tunnel.

FIG. 5 illustrates a flowchart of a security association monitoring method 500. As described above, each of the steps of the security association monitoring method 500 can be performed by processing units of a network device, configured by one or more non-transitory computer-readable media storing computer-executable instructions.

At a step 502 of the security association monitoring method 500, a processing unit of an IP tunnel gateway configures the IP tunnel gateway to advertise the IP tunnel gateway by route advertising.

As described above with reference to FIG. 3, the network device advertises the IP tunnel gateway by an implementation of BGP. The IP tunnel gateway can be advertised by BGP policy update, such as a TLV format, to state an IP tunnel protocol, such as IPsec and MACsec. A network device configured according to a dynamic tunnel bringup method can insert information entries into headers of received packets prior to forwarding those packets outbound.

In accordance with the above alternative implementations of BGP, route advertisement of the IP tunnel gateway can be performed by an NPU of the network device, peering with other network devices by Interior Gateway Protocol (“IGP”). Alternatively, route advertisement of the IP tunnel gateway can be configured by a BGP policy stored at a central controller of an access-controlled network domain, such as a BGP route reflector or a BGP speaking controller.

At a step 504 of the security association monitoring method 500, a processing unit of the IP tunnel gateway configures the network device to update an advertised IP tunnel in a routing table based on a key exchange session being brought down at a cryptographic engine of the network device.

As described above with reference to FIG. 3, an IP tunnel is updated in a routing table in response to a key exchange session being brought up by a cryptographic engine of the network device. Subsequently, upon the network device bringing down the key exchange session, the IP tunnel is updated in the routing table to reflect the fact that outbound packets can no longer be securely forwarded over the IP tunnel.

At a step 506 of the security association monitoring method 500, a processing unit of the IP tunnel gateway configures the IP tunnel gateway to cease to advertise the IP tunnel gateway.

The NPU of the network device stops encapsulating outgoing packets to state an IP tunnel protocol configured.

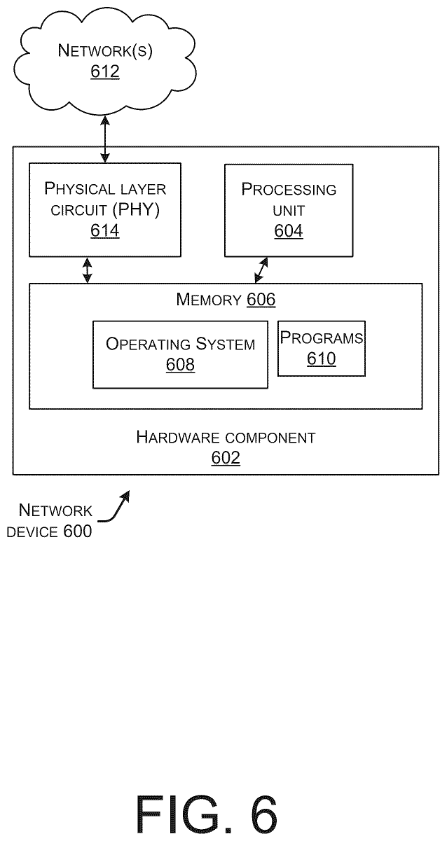

FIG. 6 shows an example architecture for a network device 600 capable of being configured to implement the functionality described above. The architecture shown in FIG. 6 illustrates a computing device assembled from modular components, and can be utilized to execute any of the software components presented herein.

The network device 600 may include one or more hardware components 602, which may be a physical card or module to which a multitude of components or devices can be connected by way of a system bus or other electrical communication paths. Such a physical card or module may be housed in a standalone network device chassis, or may be installed in a rack-style chassis alongside any number of other physical cards or modules. In one illustrative configuration, one or more processing units 604 may be standard programmable processors or programmable ASICs that perform arithmetic and logical operations necessary for the operation of the hardware component 602.

The processing units 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

Integrated circuits may provide interfaces between the processing units 604 and the remainder of the components and devices on the hardware component 602. The integrated circuits may provide an interface to memory 606 of the hardware component 602, which may be implemented as on-chip memory such as TCAM, for storing basic routines configuring startup of the hardware component 602 as well as storing other software components necessary for the operation of the hardware component 602 in accordance with the configurations described herein. The software components may include an operating system 608, programs 610, and data, which have been described in greater detail herein.

The hardware component 602 may establish network connectivity in a network 612 by forwarding packets over logical connections between remote computing devices and computer systems. The integrated circuits may provide an interface to a physical layer circuit (PHY) 614 of the hardware component 602, which may provide Ethernet ports which enable the hardware component 602 to function as an Ethernet network adapter.

The hardware component 602 can store data on the memory 606 by transforming the physical state of the physical memory to reflect the information being stored. The specific transformation of physical state can depend on various factors, in different embodiments of this description. Examples of such factors can include, but are not limited to, the technology used to implement the memory 606, whether the memory 606 is characterized as primary or secondary storage, and the like.

For example, the hardware component 602 can store information to the memory 606 by issuing instructions through integrated circuits to alter the electrical characteristics of a particular capacitor, transistor, or other discrete component in a solid-state storage unit. Other transformations of physical media are possible without departing from the scope and spirit of the present description, with the foregoing examples provided only to facilitate this description. The hardware component 602 can further read information from the memory 606 by detecting the physical states or characteristics of one or more particular locations within the memory 606.

The memory 606 described above may constitute computer-readable storage media, which may be any available media that provides for the non-transitory storage of data and that can be accessed by the hardware component 602. In some examples, the operations performed by the network device 600, and/or any components included therein, may be supported by one or more devices similar to the hardware component 602. Stated otherwise, some or all of the operations performed by the network device 600, and/or any components included therein, may be performed by one or more hardware components 602 operating in a networked, distributed or aggregated arrangement over one or more logical fabric planes over one or more networks.

By way of example, and not limitation, computer-readable storage media can include volatile and non-volatile, removable and non-removable media implemented in any method or technology. Computer-readable storage media includes, but is not limited to, TCAM, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the memory 606 can store an operating system 608 utilized to control the operation of the hardware component 602. According to one embodiment, the operating system comprises the CISCO NX-OS operating system from CISCO SYSTEMS INC. of San Jose, California. It should be appreciated that other operating systems can also be utilized. The memory 606 can store other system or application programs and data utilized by the hardware component 602.

In one embodiment, the memory 606 or other computer-readable storage media is encoded with computer-executable instructions which transform any processing units 604 from a general-purpose computing system into a special-purpose computer capable of implementing the embodiments described herein. These computer-executable instructions specify how the processing units 604 transition between states, as described above. According to one embodiment, the hardware component 602 has access to computer-readable storage media storing computer-executable instructions which, when executed by the hardware component 602, perform the various processes described above with regard to FIGS. 1-5. The hardware component 602 can also include computer-readable storage media having instructions stored thereupon for performing any of the other computer-implemented operations described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A network device comprising:
one or more processing units; and
one or more non-transitory computer-readable media storing computer-executable instructions that, when executed by the one or more processing units, cause the one or more processing units to:
discover, by route advertising, an IP tunnel gateway; and
update an advertised IP tunnel in a routing table based on the route advertising of the IP tunnel gateway.

2. The network device of claim 1, wherein the instructions further cause the one or more processing units to register a network interface based on the routing table update.

3. The network device of claim 1, wherein the instructions further cause the one or more processing units to configure a cryptographic engine of the network device to bring up a key exchange session according to a key exchange protocol.

4. The network device of claim 3, wherein the instructions further cause the one or more processing units to update the advertised IP tunnel in the routing table to identify the key exchange session.

5. The network device of claim 4, wherein the instructions further cause the one or more processing units to update a forwarding table based on the updated advertised IP tunnel in the routing table.

6. The network device of claim 5, wherein the instructions further cause the one or more processing units to encapsulate path information of an outbound packet according to a tunneling protocol and according to the updated forwarding table.

7. The network device of claim 6, wherein the instructions further cause the one or more processing units to configure the cryptographic engine of the network device to encrypt encapsulated path information of the outbound packet.

8. A method comprising:
discovering, by a network device by route advertising, an IP tunnel gateway; and
updating, by the network device, an advertised IP tunnel in a routing table based on the route advertising of the IP tunnel gateway.

9. The method of claim 8, further comprising registering, by the network device, a network interface based on the routing table update.

10. The method of claim 8, further comprising bringing up, by a cryptographic engine of the network device, a key exchange session according to a key exchange protocol.

11. The method of claim 10, further comprising updating, by the network device, the advertised IP tunnel in the routing table to identify the key exchange session.

12. The method of claim 11, further comprising updating, by the network device, a forwarding table based on the updated advertised IP tunnel in the routing table.

13. The method of claim 12, further comprising encapsulating, by the network device, path information of an outbound packet according to a tunneling protocol and according to the updated forwarding table.

14. The method of claim 13, further comprising encrypting, by the cryptographic engine of the network device, encapsulated path information of the outbound packet.

15. A network device configured as an IP tunnel gateway, comprising:
one or more processing units; and
one or more non-transitory computer-readable media storing computer-executable instructions that, when executed by the one or more processing units, cause the one or more processing units to:
advertise the IP tunnel gateway by route advertising;
update an advertised IP tunnel in a routing table based on a key exchange session being brought down at a cryptographic engine of the network device; and
cease to advertise the IP tunnel gateway.

16. The network device of claim 15, wherein the route advertising is configured by a locally stored network policy implemented according to Border Gateway Protocol (“BGP”).

17. The network device of claim 15, wherein the route advertising is configured by network policy stored at a central policy store of an access-controlled network domain, the network policy being implemented according to Border Gateway Protocol (“BGP”).

18. The network device of claim 15, wherein the route advertising is configured by a network policy applied over network devices reachable over a range of IP addresses identified by a common IP prefix.

19. The network device of claim 15, wherein the route advertising is configured by a network policy applied over network devices reachable over a common VRF (“virtual routing and forwarding”) virtually defined by a routing table.

20. The network device of claim 15, wherein the route advertising is configured by a network policy applied over network devices reachable over a common BGP community defined by a BGP color tag.
